(19) United States
(12) Patent Application Publication
(10) Pub. No.: US 2012/0236363 A1
(43) Pub. Date: Sep. 20, 2012

(54) RECORDING DEVICE, RECORDING SYSTEM, AND METHOD OF CONTROLLING A RECORDING DEVICE

(75) Inventors: Minoru Nagaoka, Suwa-shi (JP); Keiko Negishi, Suwa-shi (JP)

(73) Assignee: SEIKO EPSON CORPORATION, Shinjuku-ku (JP)

(21) Appl. No.: 13/421,747

(22) Filed: Mar. 15, 2012

(30) Foreign Application Priority Data
Mar. 16, 2011 (JP) 2011-058307

(51) Int. Cl. G06K 15/02

(52) U.S. Cl. 358/1.15

(57) ABSTRACT

Jobs can be executed continuously by using buffer efficiently. A printer-side control unit divides an image buffer into blocks of a size that can store at least the image data for the largest image included in the image data of an input job, and writes the image data for one job to one block.

Priority is claimed under 35 U.S.C. §119 to Japanese Application No. 2011-058307 filed on Mar. 16, 2011, which is hereby incorporated by reference in its entirety.

### BACKGROUND

1. Technical Field

The present invention relates to a recording device that records by ejecting ink from an inkjet line head onto a recording medium conveyed in a conveyance direction, to a recording system including the recording device and a control device that is connectable to the recording device, and a method of controlling the recording device.

2. Related Art

Recording devices that record images on a recording medium by ejecting ink from a stationary inkjet line head onto a recording medium conveyed in a conveyance direction are known from the literature. See, for example, Japanese Unexamined Patent Appl. Pub. JP-A-2010-12625.

Some recording devices of this type can sequentially execute jobs that perform a series of processes related to recording an image and are consecutively input to the recording device. When a sequence of processes related to recording an image is executed by running a job, the recording device stores image data for the image to be recorded on the recording medium to a specific buffer when the job is executed, and records images based on the stored data.

Because of the ability to execute jobs continuously, the recording device needs to use the buffer efficiently.

### SUMMARY

The invention enables using the buffer efficiently so that jobs can be executed continuously.

One aspect of the invention is a recording device that can connect to a control device and has: a conveyance unit that conveys a recording medium; an inkjet line head that ejects ink to the recording medium conveyed by the conveyance unit; a reception unit that receives a job related to recording an image from the control device; a storage unit that has a buffer; and a control unit that writes recording data for an image to be recorded to the recording medium by the inkjet line head by line unit to the buffer based on the job received by the reception unit, controls the conveyance unit and the inkjet line head and records on the recording medium based on the recording data stored in the buffer, receives the job or information related to the job through the reception unit, segments the buffer by a specific size into a plurality of blocks based on a received job or job-related information, and stores the recording data for each job to the separate blocks by job.

Because the buffer is divided and blocks are formed based on a job or information related to a job, the buffer can be divided into plural blocks of a suitable size reflecting the size of the recording data generated for each job. In addition, because recording data for each job is stored in a corresponding block, recording data for each of multiple jobs can be efficiently stored in the buffer when a plurality of jobs are input and the input plural jobs are executed sequentially.

In a recording device according to another aspect of the invention, the recording medium is label paper having label parts of a specific size affixed to a liner with a gap therebetween; and the control unit acquires the size of the label part based on the job or information related to the job received through the reception unit, and segments the buffer and forms the blocks of a specific size according to the acquired size of the label part.

The size of the blocks formed in the buffer in this aspect of the invention corresponds to the size of the label part, and recording data for an image to be recorded to the label part can be stored efficiently in the buffer.

In a recording device according to another aspect of the invention, the control unit acquires the length of the label part in the conveyance direction based on the job or information related to the job received through the reception unit, and segments the buffer every specific number of lines and forms the blocks of a specific size according to the acquired length of the label part in the conveyance direction.

The size of the blocks formed in the buffer, or more specifically the number of lines constituting a block, in this aspect of the invention corresponds to the length of the label part in the conveyance direction, and recording data for an image to be recorded to the label part can be stored efficiently in the buffer.

Another aspect of the invention is a recording system including a recording device that has a conveyance unit that conveys a recording medium, an inkjet line head that ejects ink to the recording medium conveyed by the conveyance unit, a reception unit that receives a job related to recording an image from the control device, a storage unit that has a buffer, and a control unit that writes recording data for an image to be recorded to the recording medium by the inkjet line head by line unit to the buffer based on the job received by the reception unit, and controls the conveyance unit and the inkjet line head and records on the recording medium based on the recording data stored in the buffer; and a control device that can connect to the recording device. The control device sends the job or information related to the job to the recording device, and the recording device segments the buffer by a specific size into a plurality of blocks based on the job or information related to the job received through the reception unit, and stores the recording data for each job to the separate blocks by job.

Because the buffer is divided and blocks are formed based on a job or information related to a job, the buffer can be divided into plural blocks of a suitable size reflecting the size of the recording data generated for each job. In addition, because recording data for each job is stored in a corresponding block, recording data for each of multiple jobs can be efficiently stored in the buffer when a plurality of jobs are input and the input plural jobs are executed sequentially.

Another aspect of the invention is a method of controlling a recording device that can connect to a control device and has a conveyance unit that conveys a recording medium, an inkjet line head that ejects ink to the recording medium conveyed by the conveyance unit, a reception unit that receives a job related to recording an image from the control device, a storage unit that has a buffer, and a control unit that writes recording data for an image to be recorded to the recording medium by the inkjet line head by line unit to the buffer based on the job received by the reception unit, controls the conveyance unit and the inkjet line head and records on the recording medium based on the recording data stored in the buffer, the control method including as steps executed by the control unit: receiving a job or information related to a job through the reception unit; and segmenting the buffer by a specific size into a plurality of blocks based on a received job or job-related information; and storing the recording data for each job to the separate blocks by job.

Because the buffer is divided and blocks are formed based on a job or information related to a job with this control method, the buffer can be divided into plural blocks of a suitable size reflecting the size of the recording data generated for each job. In addition, because recording data for each job is stored in a corresponding block, recording data for each of multiple jobs can be efficiently stored in the buffer when a plurality of jobs are input and the input plural jobs are executed sequentially.

Another aspect of the invention is a program that is executed by a control unit that controls a recording device that can connect to a control device and has a conveyance unit that conveys a recording medium, an inkjet line head that ejects ink to the recording medium conveyed by the conveyance unit, a reception unit that receives a job related to recording an image from the control device, and a storage unit that has a buffer, the program causing the control unit to: write recording data for an image to be recorded to the recording medium by the inkjet line head by line unit to the buffer based on the job received by the reception unit; control the conveyance unit and the inkjet line head and records on the recording medium based on the recording data stored in the buffer; receive a job or information related to a job through the reception unit; segment the buffer by a specific size into a plurality of blocks based on the received job or job-related information; and store the recording data for each job to the separate blocks by job.

Because the buffer is divided and blocks are formed based on a job or information related to a job by running this program, the buffer can be divided into plural blocks of a suitable size reflecting the size of the recording data generated for each job. In addition, because recording data for each job is stored in a corresponding block, recording data for each of multiple jobs can be efficiently stored in the buffer when a plurality of jobs are input and the input plural jobs are executed sequentially.

Another aspect of the invention is a recording device that records by ejecting ink from an inkjet line head to a recording medium conveyed in a conveyance direction, has jobs that cause executing a single process related to recording an image input thereto, and is configured to sequentially execute the input jobs, and when executing one job, write the image data for the image to be recorded to a buffer, and record an image based on the buffered image data. The recording device has a control unit that divides the buffer into blocks of a size that can store at least the image data of the largest size included in the image data for the input jobs, and stores the image data in the separate blocks.

This prevents the block size from becoming undesirably large relative to the size of the image data related to the input jobs, thereby enables creating the greatest number of blocks in the buffer, and when plural jobs are input sequentially, enables writing image data for the greatest number of jobs to the buffer. More specifically, the buffer can be used efficiently to execute jobs sequentially.

Another aspect of the invention is a recording device that can record images on the label parts of label paper having label parts of a specific size formed with a gap therebetween while conveying the label paper in the conveyance direction. One job causes execution of a continuous process related to recording an image on one label part. The control unit acquires the size of the label part, and based on the acquired size of the label part divides the buffer into blocks of a size that, when an image that fills the label part is recorded, is at least large enough to store all of the image data for the image.

In this aspect of the invention the image data for the image is image data of the largest size when recording an image that fills one label part.

This prevents the block size from becoming undesirably large relative to the size of the image data related to the input jobs, thereby enables creating the greatest number of blocks in the buffer, and when plural jobs are input sequentially, enables writing image data for the greatest number of jobs to the buffer. More specifically, the buffer can be used efficiently to execute jobs sequentially.

In a recording device according to another aspect of the invention, the buffer is a storage area that is formed with a plurality of lines arranged in the direction corresponding to the conveyance direction, and stores image data by line unit. The control unit gets the length in the conveyance direction of the label part, and divides the buffer into blocks each containing the number of lines corresponding to the acquired length of the label part in the conveyance direction.

In this aspect of the invention the area in the buffer corresponding to the entire area of one label part is an area with the number of lines corresponding to the length of the one label part in the conveyance direction.

As a result, this aspect of the invention prevents forming blocks with an undesirably large number of lines relative to the line count of the lines needed to write the image data related to the input jobs, thereby enables creating the greatest number of blocks in the buffer, and when plural jobs are input sequentially, enables writing image data for the greatest number of jobs to the buffer. More specifically, the buffer can be used efficiently to execute jobs sequentially.

Another aspect of the invention is a recording system including a recording device that ejects ink from an inkjet line head and records on a recording medium conveyed in a conveyance direction, and a control device that can connect to the recording device. The control device continuously outputs jobs that cause executing a continuous process related to recording an image, and outputs information related to the image data of the largest size included in the image data for each of the output jobs. The recording device is configured to sequentially execute the jobs input from the control device, write image data for the image to be recorded to a buffer to execute one job, and execute image recording based on the stored image data, and has a control unit that divides the buffer into blocks of a size that can store at least the image data of the largest size included in the image data for the input jobs based on the information input from the control device, and writes the image data individually to the separate blocks.

This prevents the block size from becoming undesirably large relative to the size of the image data related to the input jobs, thereby enables creating the greatest number of blocks in the buffer, and when plural jobs are input sequentially, enables writing image data for the greatest number of jobs to the buffer. More specifically, the buffer can be used efficiently to execute jobs sequentially.

Another aspect of the invention is a program executed by a control unit to control a recording device that records by ejecting ink from an inkjet line head to a recording medium conveyed in a conveyance direction, has jobs that cause executing a single process related to recording an image input thereto, and is configured to sequentially execute the input jobs, and when executing one job, write the image data for the image to be recorded to a buffer, and record an image based on the buffered image data. The program causes the control unit to divide the buffer into blocks of a size that can store at least the image data of the largest size included in the image data for the input jobs, and store the image data in the separate blocks.

Executing this program can prevent the block size from becoming undesirably large relative to the size of the image data related to the input jobs, thereby enables creating the greatest number of blocks in the buffer, and when plural jobs are input sequentially, enables writing image data for the greatest number of jobs to the buffer. More specifically, the buffer can be used efficiently to execute jobs sequentially.

### EFFECT OF THE INVENTION

The invention enables using a buffer efficiently to execute jobs sequentially.

### BRIEF DESCRIPTION OF THE DRAWINGS

FIG. 1 shows the configuration of an inkjet line printer.

FIG. 2 shows label paper.

FIG. 3 is a block diagram showing the functional configuration of a recording system.

FIG. 4 shows an image buffer.

FIG. 5 is a flow chart of recording system operation.

### DESCRIPTION OF EMBODIMENTS

A preferred embodiment of the present invention is described below with reference to the accompanying figures.

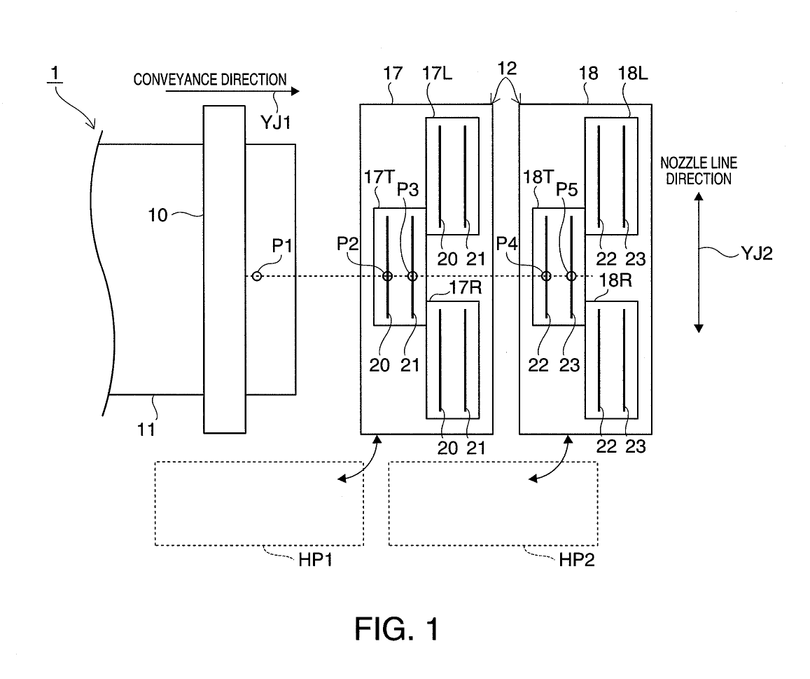

FIG. 1 schematically describes the configuration of an inkjet line printer 1 (recording device) according to this embodiment of the invention.

The inkjet line printer 1 is an inkjet printer with a line printhead that records images on a recording medium 11 by ejecting ink from an inkjet line head 12 onto the recording medium 11 while conveying the recording medium 11 in the paper feed direction (indicated by arrow YJ1 in FIG. 1) with a paper feed roller 10.

The inkjet line printer 1 can record images at least on label paper 14, which is a recording medium 11 as described below.

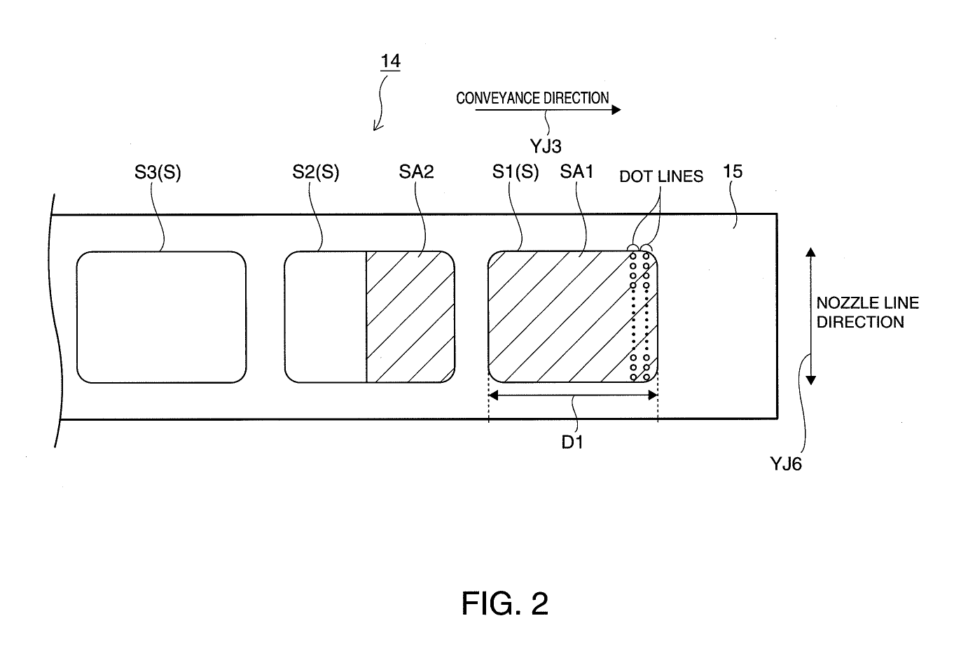

FIG. 2 schematically describes the label paper 14.

As shown in FIG. 2, the label paper 14 has a long, narrow shape with label parts S formed with a specific gap therebetween on the recording surface 15. Seals are adhesively affixed to the liner at the location of each label part S, and can be peeled away from the surrounding waste matrix. The size of the label parts S is uniform, and the interval between label parts S is also uniform. The inkjet line printer 1 records an image in each of the label parts S formed on the label paper 14.

When the inkjet line printer 1 records on the label paper 14, the label paper 14 is set in the inkjet line printer 1 so that the length of the label paper 14 is aligned with the conveyance direction, and specific images are recorded desirably to the label parts S as the label paper 14 is conveyed in the conveyance direction.

The label parts S on which images are recorded are used as labels, for example.

As shown in FIG. 1, the inkjet line printer 1 has an upstream head unit 17 and a downstream head unit 18.

The upstream head unit 17 has three staggered recording heads, upstream top recording head 17T, upstream left recording head 17L, and upstream right recording head 17R. The downstream head unit 18 similarly has three staggered recording heads, downstream top recording head 18T, downstream left recording head 18L, and downstream right recording head 18R.

A black nozzle line 20, and a cyan nozzle line 21 disposed downstream from the black nozzle line 20, are disposed to the upstream top recording head 17T.

The black nozzle line 20 is a nozzle line having nozzles (not shown) that eject ink as fine ink droplets formed in the nozzle line direction (indicated by arrow YJ2 in FIG. 1), which is perpendicular to the conveyance direction. Ink is supplied to the black nozzle line 20 from a black (K) ink cartridge (not shown), and the upstream top recording head 17T pushes ink supplied from the black (K) ink cartridge by an actuator such as a piezoelectric device toward the recording medium 11, ejecting fine ink droplets from specific nozzles.

Similarly to the black nozzle line 20, the cyan nozzle line 21 is a nozzle line of nozzles formed in the nozzle line direction, and has ink supplied from a cyan (C) ink cartridge (not shown).

The upstream right recording head 17R and the upstream left recording head 17L are configured identically to the upstream top recording head 17T, and have a black nozzle line 20, and a cyan nozzle line 21 disposed on the downstream side of the black nozzle line 20, respectively.

A magenta nozzle line 22, and a yellow nozzle line 23 located downstream from the magenta nozzle line 22, are disposed to the downstream top recording head 18T.

Like the black nozzle line 20, the magenta nozzle line 22 is a nozzle line of nozzles formed in the nozzle line direction, and has ink supplied from a magenta (M) ink cartridge (not shown).

Like the black nozzle line 20, the yellow nozzle line 23 is a nozzle line of nozzles formed in the nozzle line direction, and has ink supplied from a yellow (Y) ink cartridge (not shown).

The downstream right recording head 18R and downstream left recording head 18L are configured identically to the downstream top recording head 18T, and respectively have a magenta nozzle line 22 and a yellow nozzle line 23 disposed on the downstream side of the magenta nozzle line 22.

Note that the recording heads and the nozzle lines of the recording heads are shown in FIG. 1 for convenience of description, but the recording heads are actually configured to eject ink vertically downward from the nozzles of the nozzle lines, and the various parts are disposed to achieve this configuration.

The inkjet line printer 1 ejects ink and forms dots on the recording medium 11, and records images by the combination of dots. The basic operation for forming a single dot on the recording medium 11 is described briefly using FIG. 1.

Forming a dot of a specific color at a desired position P1 on the recording medium 11 when the recording medium 11 is set to a position as shown in FIG. 1 is described below. The specific color is a color that is achieved by ejecting specific amounts of black (K), cyan (C), magenta (M), and yellow (Y) ink. Position P2 in FIG. 1 is the position where position P1 on the conveyed recording medium 11 passes the black nozzle line 20 of the upstream top recording head 17T. Position P3, position P4, and position P5 are similar positions.

The inkjet line printer 1 conveys the recording medium 11 in a specific direction at a predetermined constant speed while forming dots on the recording medium 11. Conveyance proceeds in the conveyance direction of the recording medium 11 from the position shown in FIG. 1, and the inkjet line printer 1 ejects a specific amount of black (K) ink timed to position P1 on the recording medium 11 reaching the position corresponding to position P2. The inkjet line printer 1 likewise ejects a specific amount of cyan (C) ink timed to position P1 on the recording medium 11 reaching the position corresponding to position P3, ejects a specific amount of magenta (M) ink timed to position P1 on the recording medium 11 reaching the position corresponding to position P4, and ejects a specific amount of yellow (Y) ink timed to position P1 on the recording medium 11 reaching the position corresponding to position P5. Specific amounts of black (K), cyan (C), magenta (M), and yellow (Y) ink are thus ejected to position P1 on the recording medium 11, and a dot of a specific color is formed at position P1.

With a inkjet line printer 1 according to this embodiment of the invention, the positions of the recording heads are fixed during the process related to recording an image, the recording medium 11 moves relative to the stationary recording heads, ink is desirably ejected from the recording heads to form dots, and an image is recorded.

The inkjet line printer 1 is also capable of performing a flushing process.

Ink viscosity can increase due to drying and result in ink ejection problems in the nozzles formed in each nozzle line, particularly in nozzles that are not used and nozzles that are used infrequently. Flushing is an operation that is performed to prevent such ejection problems.

More specifically, the upstream head unit 17 and the downstream head unit 18 are mounted respective carriages. The upstream head unit 17 can move to home position HP1 shown FIG. 1, and the downstream head unit 18 can move to home position HP2, by means of the carriage.

A box-like cap with an open top is disposed to home position HP1. This cap receives ink ejected from the recording heads of the upstream head unit 17 when positioned to home position HP1, and can discharge the ejected ink as waste ink into a collection tank. An identical cap is also disposed to home position HP2.

To flush the recording heads of the upstream head unit 17, the upstream head unit 17 is first moved by the carriage to the home position HP1. A specific amount of ink is then ejected from nozzles of the recording heads included in the upstream head unit 17 (all nozzles or only specific nozzles selected based on usage frequency, for example). Ink that has increased in viscosity is thus expelled from the nozzles, and ejection problems are prevented. When flushing is completed, the upstream head unit 17 returns to a specific position from the home position HP1, enabling execution of the process related to recording an image. The downstream head unit 18 is flushed in the same way.

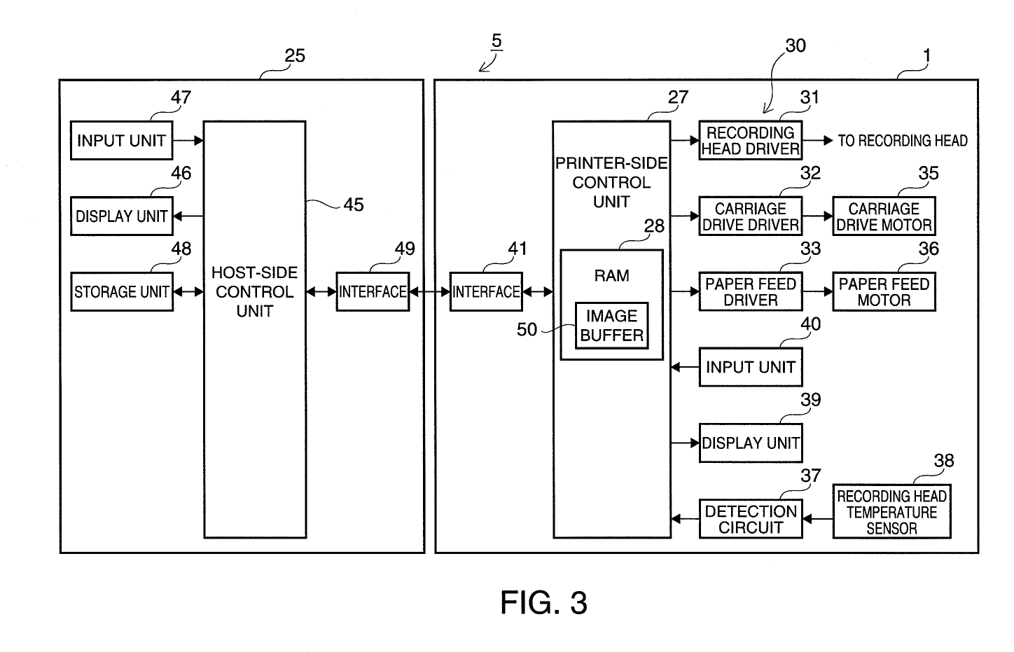

FIG. 3 is a block diagram showing the functional configuration of a recording system 5 including the inkjet line printer 1 according to this embodiment of the invention, and a host computer 25 (control device) that controls this inkjet line printer 1.

The inkjet line printer 1 includes a printer-side control unit 27 (control unit) and a driver circuit unit 30.

The printer-side control unit 27 centrally controls parts of the inkjet line printer 1, and includes a CPU as an operating unit, a basic control program that can be executed by the CPU, ROM that nonvolatilely stores this basic control program and data, RAM 28 (storage unit) that temporarily stores the program executed by the CPU and data related to the program, and other peripheral circuits.

The driver circuit unit 30 includes a recording head driver 31, carriage drive driver 32, and paper feed driver 33.

The recording head driver 31 is connected to each recording head, and as controlled by the printer-side control unit 27 drives the actuators of each recording head to eject the required amount of ink from the nozzles.

The carriage drive driver 32 is connected to a carriage drive motor 35, and as controlled by the printer-side control unit 27 moves the upstream head unit 17 and/or the downstream head unit 18 from the position where the recording operation can be performed to home position HP1, HP2, and from the home position HP1, HP2 to the position where the recording operation can be performed.

The paper feed driver 33 is connected to the paper feed motor 36, outputs a drive signal to the paper feed motor 36, and causes the paper feed motor 36 to operate only the amount specified by the printer-side control unit 27. As the paper feed motor 36 operates, the paper feed roller 10 turns, and the recording medium 11 is conveyed a specific amount in the conveyance direction or the reverse of the conveyance direction. The printer-side control unit 27, paper feed driver 33, paper feed motor 36, and paper feed roller 10 cooperate to function as a conveyance unit.

The detection circuit 37 is connected to a recording head temperature sensor 38. The recording head temperature sensor 38 is disposed near one of the recording heads, detects the temperature of the recording head, and outputs to the printer-side control unit 27. Based on the output from the recording head temperature sensor 38, the printer-side control unit 27 detects the temperature of the recording head.

A display unit 39 is connected to the printer-side control unit 27, and operation of multiple LEDs disposed to the display unit 39 can be controlled by the printer-side control unit 27. An input unit 40 is also connected to the printer-side control unit 27, and operating signals are input from the input unit 40 to the printer-side control unit 27 when the operator operates switches disposed to the input unit 40.

The interface 41 includes a connected that is connected to the host computer 25, and an interface circuit that implements a specific communication protocol through the connector. The interface 41 and the host computer 25 are connected using a standard such as IEEE 1284, USB (Universal Serial Bus), or IEEE 1394. Note that a configuration in which the interface 41 is connected to the host computer 25 through a LAN (local area network) using a wired or wireless communication path is also conceivable. In this case a plurality of host computers 25 could be connected to the inkjet line printer 1.

The interface 41 and the printer-side control unit 27 cooperate to function as a reception unit that receives jobs and job-related information (described below).

The host computer 25 includes a host-side control unit 45, display unit 46, input unit 47, storage unit 48, and interface 49.

The host-side control unit 45 centrally controls the parts of the host computer 25, and like the printer-side control unit 27 includes a CPU, ROM, RAM, and peripheral circuits.

The display unit 46 is an LCD panel or organic electroluminescent panel, for example, and displays information on the display panel as controlled by the host-side control unit 45.

The input unit 47 is connected to input devices, and outputs output signals from the input devices to the host-side control unit 45.

The storage unit 48 is a storage device such as a hard disk drive or EEPROM device, and stores data rewritably.

Like the interface 41 described above, the interface 49 communicates with the inkjet line printer 1 as controlled by the host-side control unit 45.

The printer-side control unit 27 controls parts of the driver circuit unit 30 based on control commands input from the host computer 25, and performs the operation that records images on the recording medium 11.

A printer control program such as a printer driver for controlling the inkjet line printer 1 is installed to the host computer 25. The host-side control unit 45 outputs appropriate control commands to the inkjet line printer 1 by reading and running the printer control program.

The operation of the host computer 25 and the inkjet line printer 1 when recording an image on the label paper 14 described above is described next.

The label paper 14 shown in FIG. 2 is set in the inkjet line printer 1 so that the right end in FIG. 2 is the leading end and the length of the paper matches the conveyance direction, and is conveyed appropriately in the direction indicated by arrow YJ3 as the conveyance direction.

Images are recorded to label part S1 and label part S2 in the example in FIG. 2. More particularly, an image is recorded to area SA1 of label part S1 and area SA2 of label part S2. Area SA1 of label part S1 is all of label part S1 (the shaded area in label part S1 in FIG. 2). Area SA2 extends a specific distance in the reverse of the conveyance direction from the end on the conveyance direction side of the label part S2 (the shaded portion of label part S2 in FIG. 2).

When recording an image to label paper 14 in the example in FIG. 2, the host computer 25 first outputs a set of control commands that cause the inkjet line printer 1 to execute a single process related to recording an image in area SA1 of label part S1, and then outputs a set of control commands for executing a single process related to recording an image in area SA2 of label part S2.

The single process related to recording an image in one label part S is the process from starting to ending recording an image on one label part S, that is, a process of ejecting a required amount of ink from the recording heads while conveying the label paper 14 and recording an image on one label part S.

The printer-side control unit 27 of the inkjet line printer 1 manages the single process related to recording an image on label part S1 and label part S2 as two jobs, job J1 and job J2. Executing a job as used below means sequentially executing the set of control commands related to recording an image on a specific label part S, and executing the single process related to recording an image on the specific label part S. For example, executing job J1 means sequentially executing the set of control commands related to recording an image to the area SA1 of label part S1, and recording an image in area SA1 of label part S1, and executing job J2 means sequentially executing the set of control commands related to recording an image to the area SA2 of label part S2, and recording an image in area SA2 of label part S2.

The printer-side control unit 27 to which the control commands related to job J1 and control commands related to job J2 are input executes job J1 and job J2 continuously.

In addition to the image data for the image to be recorded to area SA1 of label part S1, the control commands related to job J1 include a control command for writing the image data (recording data) to a specific area in the image buffer 50 formed in a specific area of RAM 28, and a control command for recording an image based on the image data written to the image buffer 50.

Based on these commands, the printer-side control unit 27 writes all image data for the image to be recorded to area SA 1 of label part S1 to the specific area in the image buffer 50, then records the image to the area SA1 of label part S1 based on the image data stored in the image buffer 50 while conveying the label paper 14 in the conveyance direction.

Images are thus recorded in a page mode by the inkjet line printer 1 according to this embodiment of the invention. More specifically, images are recorded after all image data has been written to the image buffer 50. This means that when one job is executed by the inkjet line printer 1, all control commands related to that one job must be input from the host computer 25 and all image data can be written to the image buffer 50 before the job is executed. Note that the process of writing image data to the image buffer 50 is further described below.

The printer-side control unit 27 then records an image to the area SA2 of label part S2 by executing job J2 continuously to execution of job J1.

The printer-side control unit 27 thus continuously receives and sequentially executes a job for executing a single process related to recording an image on one label part S.

In a recording device such as the inkjet line printer 1 according to this embodiment of the invention that moves the recording medium 11 relative to stationary recording heads, has the recording heads separated in the conveyance direction, and can execute jobs continuously, processing efficiency can be improved and throughput can be improved by continuously executing as many jobs as possible at one time.

“Executing plural jobs continuously” means conveying the label paper 14 in the conveyance direction at a predetermined constant speed, and executing plural different jobs and recording images on label parts S specific to each job while continuing to paper conveyance at this constant speed.

As shown in FIG. 1, the upstream top recording head 17T of the upstream head unit 17, and the downstream top recording head 18T of the downstream head unit 18, are separated from each other in the conveyance direction in this embodiment. As a result, by executing jobs continuously when recording images to one label part S and to another label part S separated from the one label part S in the direction opposite the conveyance direction, ink can be ejected to part of the other label part S by the downstream top recording head 18T while the upstream top recording head 17T ejects ink to part of the one label part S. By holding the speed of label paper 14 conveyance in the specific direction constant, an image can be recorded on one label part S and an image can be recorded on another label part S. This also applies to the other recording head.

However, when one job for recording an image on one label part S and another job for recording an image on another label part S are not executed continuously, conveyance pauses after recording an image on the one label part S by executing one job, the label paper 14 is conveyed in the direction opposite the conveyance direction to the position for recording an image on the other label part S, and the job related to recording an image on the other label part S is executed. This is extremely disadvantageous in terms of process efficiency and throughput compared with when jobs are executed continuously.

A process whereby an image buffer 50 is formed in RAM 28, and image data (recording data) is written to the image buffer 50, is described next.

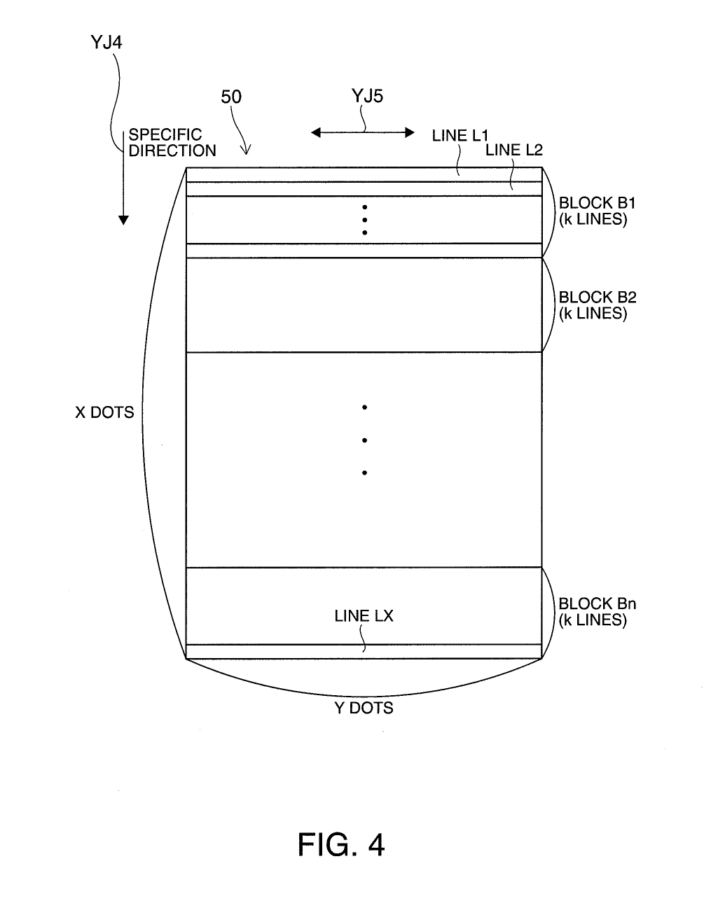

FIG. 4 schematically describes the state of the image buffer 50 when writing image data of a specific resolution.

This image buffer 50 is a buffer that can store image data for recording to plural different label parts S.

In the example in FIG. 4 the image buffer 50 is an area that can store pixels for X dots in a specific direction (arrow YJ4), and Y dots in a line direction (arrow YJ5) that is perpendicular to the specific direction. The image buffer 50 is formed with a plurality (X) of lines extending in the line direction (line L1 to line LX) arrayed in the specific direction.

The specific direction (arrow YJ4 in FIG. 4) in the image buffer 50 corresponds to the conveyance direction (arrow YJ1 in FIG. 1 and arrow YJ3 in FIG. 2), and the line direction (arrow YJ5 in FIG. 4) corresponds to the nozzle line direction (arrow YJ2 in FIG. 1).

The format of the image buffer 50 configured in this way corresponds to the particular configuration in which the direction in which the nozzle lines of the recording head extend (the nozzle line direction) is perpendicular to the conveyance direction, and images are formed by ejecting ink from the nozzles extending in the nozzle line direction while conveying the recording medium 11 in the conveyance direction.

Described more specifically with reference to label part 51 in FIG. 2, an image is formed in area SA1 of label part S1 by forming a plurality of dot lines that extend in the nozzle line direction (indicated by arrow YJ6 in FIG. 2) in the conveyance direction according to the resolution. Dot lines are formed by forming dots in the nozzle line direction at the resolution and the specific interval determined by the distance between nozzles in the recording head.

The dot lines correspond to the lines in the image buffer 50, and the image data for one dot line is written to one line corresponding to that dot line, and the image data for the next dot line (the dot line formed on the side of the one dot line in the direction opposite the conveyance direction) after the one dot line is written to the next line after the one line (the line on the specific direction side of the one line).

For any image recorded to a label part S, the number of dot lines rendering the image equals the number of lines used to write the image data for that image to image buffer 50 with this configuration.

The length of the label part S in the conveyance direction (length D1 for label part S1 in FIG. 2) therefore uniformly determines the number of dot lines in the image data for an image that when recorded at a specific resolution fills the entire label part S, and uniformly determines the number of lines to which the image data is written in the image buffer 50.

In this embodiment of the invention the image data for one job is written to one block.

More specifically, as shown in FIG. 4, when buffering image data, the image buffer 50 is divided into n blocks (block B1 to block Bn) each containing a specific number of lines (k lines in FIG. 4). The configuration of the blocks is described later. When plural jobs are then input, the image data for each of the plural jobs is written sequentially block by block in the specific direction.

Described more specifically using the example in FIG. 2, when inputting job J1 and job J2 from the host computer 25 starts, the printer-side control unit 27 creates the image buffer 50 in RAM 28, and divides the image buffer 50 into blocks (block B1 to block Bn). All image data for job J1 is written to block B1 before recording the image to area SA1 of label part S1, and all image data for job J2 is written to block B2 before recording the image to area SA2 of label part S2.

The reason for dividing the image buffer 50 into blocks is described next.

Plural jobs are output continuously from the host computer 25 to the inkjet line printer 1 in this embodiment, but when one job is followed by a next job to be executed next after the one job, all image data for the one job will not necessarily be input to the inkjet line printer 1 before the image data for the next job. For example, when the image data for the one job is segmented into plural parts and sent in packets from the host computer 25 to the inkjet line printer 1, and the image data for the next job is likewise segmented into plural parts and sent in packets, some packets containing image data for the next job could be input before all packets containing the image data for the one job have been input depending upon the communication conditions. In this case, if writing the image data for the next job to the image buffer 50 pauses until all image data for the one job is input, and the image data for the next job is written to suitable empty memory after all image data for the one job has been input and all of the image data has been written to the image buffer 50, an unnecessary delay is created, processing efficiency drops, and the time required for the process may be increased.

However, by first dividing the image buffer 50 into blocks, this embodiment of the invention can write image data for different jobs simultaneously in parallel to different blocks when plural jobs are input, thus improving process efficiency and shortening the time required for the process.

As described above, the label paper 14 is paper with label parts S of a specific size formed at a specific interval, but the size of the label parts S depends upon the label specifications. The amount of data in the image data used to record an image throughout all of one label part S, that is, the maximum size of the image data for an image recorded to a label part S, differs according to the specifications of the label paper 14.

As a result, the number of lines constituting one block is determined in the related art so that at least the image data for an image to be recorded filling the label part S of label paper 14 of a standard having label parts S of the largest size (image data of the largest size expected when recording images to the label parts S of label paper 14 of this standard) can be written.

For example, if the number of dot lines of a recorded image that covers all of a label part S of label paper 14 of this standard is 1000, the number of lines constituting each block that is formed in the image buffer 50 is 1000. Note that for brevity, the total number of lines in the image buffer 50 can be evenly divided by 1000.

By thus determining the number of lines in each block, the image data for one image can be reliably written to one block when recording images to label paper 14 conforming to any standard.

However, depending on the label paper 14 specifications, the amount of image data written to one block may be unnecessarily greater than the size of one block with this method of the related art, and the image buffer 50 cannot be used efficiently.

As described above, the inkjet line printer 1 according to this embodiment of the invention is advantageous in terms of process efficiency and throughput when jobs that can be executed continuously are executed continuously as much as possible. Because of this advantage, forming as many blocks as possible in the image buffer 50, that is, minimizing the number of lines in one block, is necessary so that image data for as many images as possible can be simultaneously stored in the image buffer 50.

By executing the process described below, this embodiment of the invention can reliably write image data for one image to one block, and reflecting the ability to execute jobs sequentially, uses the image buffer 50 efficiently.

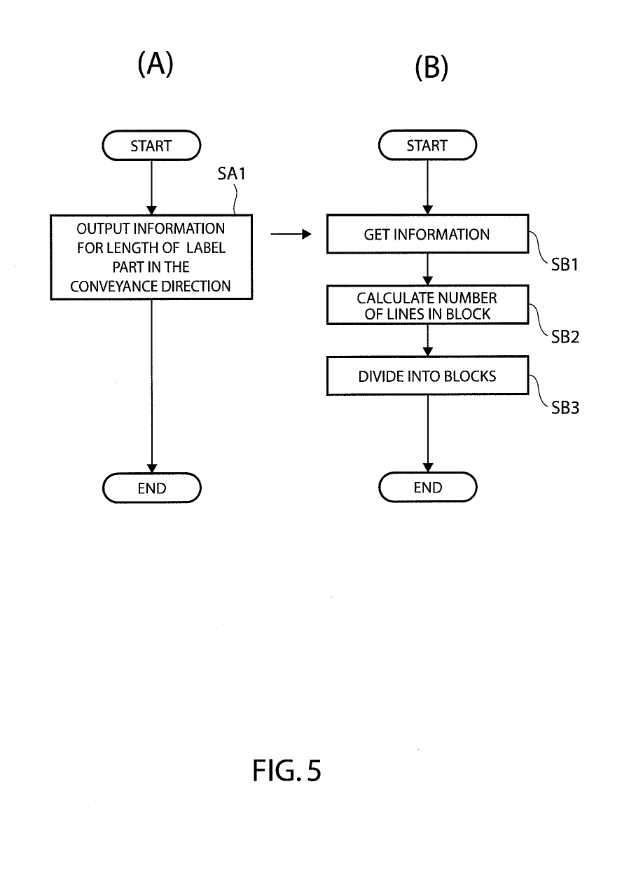

FIG. 5 is a flow chart showing the operation of the inkjet line printer 1 and the host computer 25, (A) showing the operation of the host computer 25, and (B) showing the operation of the inkjet line printer 1.

The process of dividing the image buffer 50 into blocks is extracted from the flow chart in FIG. 5 to describe the invention more clearly, but the process shown in the flow chart in FIG. 5 is normally a process included in job execution.

The host computer 25 first outputs information indicating the length in the conveyance direction of a label part S on the label paper 14 to be processed by the inkjet line printer 1 to the inkjet line printer 1 (step SA1). The information output here is the “information related to a job” or “job-related information.” The length in the conveyance direction of a label part S of the label paper 14 is previously input to the host computer 25. Output of information is done by a function of the printer driver.

When the above information is acquired (step SB1), the printer-side control unit 27 of the inkjet line printer 1 calculates the number of lines in the image data based on the length in the conveyance direction of the label parts S on the label paper 14 when image data for an image that is recorded over the entire label part S (image data for the largest expected image when recording images to the label parts S of the label paper 14) is written to the image buffer 50 (step SB2).

In step SB2, the printer-side control unit 27 first gets the number of dot lines in the image data of the image when an image that fills the label part S is recorded at the specified resolution based on the length in the conveyance direction of the label part S. Because the number of dot lines in the image data of the image is uniformly determined according to the length of the label part S in the conveyance direction when an image that fills the entire label part S is recorded, a table correlating this length to the corresponding number of dot lines is compiled and kept in memory, and the printer-side control unit 27 gets the number of dot lines by referring to this table. This acquired number of dot lines equals the line count of the lines in the image data when image data for an image that is recorded filling the entire label part S is written to the image buffer 50.

The printer-side control unit 27 then sets the line count equal to the line count calculated in step SB2 plus a specific margin as the line count of the lines in one block (step SB2).

Next, the printer-side control unit 27 then divides the image buffer 50 by the line count determined in step SB2 into blocks (step SB3).

The size of one block formed in step SB3 is large enough to reliably hold image data for the largest image expected to be recorded when recording images to the label parts S of the label paper 14 used for recording images. Image data for one image can therefore be reliably written to one block when recording images to the label parts S of the label paper 14. In addition, because one block contains the lines of the line count equal to line count calculated in step SB3 plus a specific margin, the block is also the minimum size required to store the image data for the largest expected image. The number of lines in one block can therefore be kept as small as possible and the greatest possible number of blocks can be formed in the image buffer 50. The largest possible number of images can therefore also be written to the image buffer 50, and jobs that can be executed continuously can be executed as continuously as possible.

As described above, a inkjet line printer 1 according to this embodiment of the invention is configured to sequentially execute an input job when a job that causes executing a single process related to recording an image is input, and when executing one job, write image data for the image to be recorded to an image buffer 50, and record an image based on the buffered image data. The printer-side control unit 27 also divides the image buffer 50 into blocks sized to store at least the image data of the largest size included in the image data for the input jobs, and stores the image data in the separate blocks.

This prevents the block size from becoming undesirably large relative to the size of the image data related to the input jobs, thereby enables creating the greatest number of blocks in the buffer, and when plural jobs are input sequentially, enables writing image data for the greatest number of jobs to the image buffer 50. More specifically, the image buffer 50 can be used efficiently to execute jobs sequentially.

The inkjet line printer 1 according to this embodiment of the invention can record images on the label parts S of label paper 14 having label parts S of a specific size formed with a gap therebetween while conveying the label paper 14 in the conveyance direction. One job causes execution of a continuous process related to recording an image on one label part S. The printer-side control unit 27 acquires the size of the label part S, and based on the acquired size of the label part S divides the image buffer 50 into blocks of a size that, when an image that fills the label part S is recorded, is at least large enough to store all of the image data for the image.

This prevents the block size from becoming undesirably large relative to the size of the image data related to the input jobs, thereby enables creating the greatest number of blocks in the image buffer 50, and when plural jobs are input sequentially, enables writing image data for the greatest number of jobs to the image buffer 50. More specifically, the image buffer 50 can be used efficiently to execute jobs sequentially.

The image buffer 50 in this embodiment is a storage area that is formed with a plurality of lines arranged in the direction corresponding to the conveyance direction, and stores image data by line unit. The printer-side control unit 27 gets the length in the conveyance direction of the label part S, and divides the image buffer 50 into blocks each containing the number of lines corresponding to the acquired length of the label part S in the conveyance direction.

This prevents forming blocks with an undesirably large number of lines relative to the line count of the lines needed to write the image data related to the input jobs, thereby enables creating the greatest number of blocks in the image buffer 50, and when plural jobs are input sequentially, enables writing image data for the greatest number of jobs to the image buffer 50. More specifically, the image buffer 50 can be used efficiently to execute jobs sequentially.

The printer-side control unit 27 in this embodiment receives job-related information (information indicating the length in the conveyance direction of the label part S) through an interface 41 that functions as a reception unit, divides the image buffer 50 into a plurality of blocks of a specific size based on the received information, and stores the image data (recording data) for each job in a separate block job by job.

Because the image buffer 50 is divided and blocks are formed based on this job-related information, the printer-side control unit 27 can divide the image buffer 50 and form blocks of a suitable size reflecting the size of the image data (recording data) generated for each job. In addition, because image data for each job is stored in a corresponding block, the image data for each of multiple jobs can be efficiently stored in the image buffer 50 when a plurality of jobs are input and the input plural jobs are executed sequentially.

More particularly, because the printer-side control unit 27 in this embodiment divides the image buffer 50 by a specific number of lines corresponding to the length in the conveyance direction of the label part S, creating blocks of a specific size, the number of lines in each block corresponds to the length in the conveyance direction of the label part S, and the image data for images recorded to the label parts S can be efficiently stored in the buffer.

It will be obvious to one with ordinary skill in the related art that the foregoing embodiment is one example, and can be modified and adapted in many ways without departing from the scope of the accompanying claims.

For example, the printer-side control unit 27 of the inkjet line printer 1 executes the process that forms blocks in the image buffer 50 in the embodiment described above, but part or all of this process could be executed by the host-side control unit 45 of the host computer 25. In this case the host computer 25 and the inkjet line printer 1 work together and function as a recording device.

The location and type of the recording heads, the configuration of the mechanisms used for recording, the means of flushing, the configuration of the mechanisms used for flushing, and other aspects of the foregoing embodiment are obviously also not limited to the embodiment described above. More specifically, the invention can be broadly applied to recording devices that record by ejecting ink from an inkjet line head onto a recording medium conveyed in a conveyance direction.

In addition, information denoting the length in the conveyance direction of the label part S is output as information related to a job from the host computer 25 to the inkjet line printer 1 in the foregoing embodiment, and the printer-side control unit 27 of the inkjet line printer 1 appropriately determines the number of lines in each block based on this information, but the invention is not so limited. For example, a configuration in which the printer-side control unit 27 of the inkjet line printer 1 analyzes a job input from the paper feed roller 10 to get the length in the conveyance direction of the label part S or information related to the size of the image data of an image recorded to the label parts S (such as the size of the image data for the largest image when image data for plural images is to be written to the image buffer 50), and segments the image buffer 50 based on the acquired information, is also conceivable.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A recording device that can connect to a control device and comprises:
a conveyance unit that conveys a recording medium;
an inkjet line head that ejects ink to the recording medium conveyed by the conveyance unit;
a reception unit that receives a job related to recording an image from the control device;
a storage unit that has a buffer; and
a control unit that writes recording data for an image to be recorded to the recording medium by the inkjet line head by line unit to the buffer based on the job received by the reception unit,
controls the conveyance unit and the inkjet line head and records on the recording medium based on the recording data stored in the buffer,
receives the job or information related to the job through the reception unit,
segments the buffer by a specific size into a plurality of blocks based on a received job or job-related information, and
stores the recording data for each job to the separate blocks by job.

2. The recording device described in claim 1, wherein:
the recording medium is label paper having label parts of a specific size affixed to a liner with a gap therebetween; and
the control unit acquires the size of the label part based on the job or information related to the job received through the reception unit, and segments the buffer and forms the blocks of a specific size according to the acquired size of the label part.

3. The recording device described in claim 2, wherein:
the control unit acquires the length of the label part in the conveyance direction based on the job or information related to the job received through the reception unit, and segments the buffer every specific number of lines and forms the blocks of a specific size according to the acquired length of the label part in the conveyance direction.

4. A recording system comprising:
a recording device that has a conveyance unit that conveys a recording medium,
an inkjet line head that ejects ink to the recording medium conveyed by the conveyance unit,
a reception unit that receives a job related to recording an image from the control device,
a storage unit that has a buffer, and
a control unit that writes recording data for an image to be recorded to the recording medium by the inkjet line head by line unit to the buffer based on the job received by the reception unit, and controls the conveyance unit and the inkjet line head and records on the recording medium based on the recording data stored in the buffer; and
a control device that can connect to the recording device;
wherein the control device sends the job or information related to the job to the recording device, and
the recording device segments the buffer by a specific size into a plurality of blocks based on the job or information related to the job received through the reception unit, and stores the recording data for each job to the separate blocks by job.

5. The recording system described in claim 4, wherein:
the recording medium is label paper having label parts of a specific size affixed to a liner with a gap therebetween; and
the recording device acquires the size of the label part based on the job or information related to the job received through the reception unit, and segments the buffer and forms the blocks of a specific size according to the acquired size of the label part.

6. The recording system described in claim 5, wherein:
the recording device acquires the length of the label part in the conveyance direction based on the job or information related to the job received through the reception unit, and segments the buffer every specific number of lines and forms the blocks of a specific size according to the acquired length of the label part in the conveyance direction.

7. A method of controlling a recording device that can connect to a control device and has
a conveyance unit that conveys a recording medium,
an inkjet line head that ejects ink to the recording medium conveyed by the conveyance unit,
a reception unit that receives a job related to recording an image from the control device,
a storage unit that has a buffer, and
a control unit that writes recording data for an image to be recorded to the recording medium by the inkjet line head by line unit to the buffer based on the job received by the reception unit, controls the conveyance unit and the inkjet line head and records on the recording medium based on the recording data stored in the buffer,
the control method comprising as steps executed by the control unit:
receiving a job or information related to a job through the reception unit; and
segmenting the buffer by a specific size into a plurality of blocks based on a received job or job-related information; and
storing the recording data for each job to the separate blocks by job.

8. The method of controlling a recording device described in claim 7, wherein:
the recording medium is label paper having label parts of a specific size affixed to a liner with a gap therebetween; and
the control unit acquires the size of the label part based on the job or information related to the job received through the reception unit, and segments the buffer and forms the blocks of a specific size according to the acquired size of the label part.

9. The method of controlling a recording device described in claim 8, wherein:
the control unit acquires the length of the label part in the conveyance direction based on the job or information related to the job received through the reception unit, and segments the buffer every specific number of lines and forms the blocks of a specific size according to the acquired length of the label part in the conveyance direction.
